(19) United States
(12) Patent Application Publication
(10) Pub. No.: US 2019/0099003 A1
(43) Pub. Date: Apr. 4, 2019

(54) Inflatable Chair Pad Assembly

(71) Applicants: Jeffrey Patrick, New Bethehem, PA (US); Christine Patrick, New Bethlehem, PA (US)

(72) Inventors: Jeffrey Patrick, New Bethehem, PA (US); Christine Patrick, New Bethlehem, PA (US)

(21) Appl. No.: 15/725,027

(22) Filed: Oct. 4, 2017

(51) Int. Cl. A47C 7/46; B60N 2/44; A47C 1/06; B60N 2/20; A47C 1/024; A47C 7/50; B60N 2/02; A47C 31/00

(52) U.S. Cl. CPC A47C 7/467; B60N 2/4415; A47C 1/06; B60N 2/20; B60N 2/4495; A47C 7/506; B60N 2/0244; A47C 31/00; A47C 1/024

(57) ABSTRACT

An inflatable chair pad assembly for selectively cushioning a user includes a chair, such as one that is positioned in a vehicle, a residence, an office, and a barber shop. The chair has a seat and a backrest. The backrest is coupled to and extends from a rear edge of the seat. The backrest is configured to support a head, a neck, and a back of a user who is positioned upon the seat. A first bladder is coupled to a front of the backrest. The first bladder is selectively inflatable. The first bladder is configured to be selectively inflated to cushion the head, the neck, and the back of the user who is positioned upon the seat.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to chair pad assemblies and more particularly pertains to a new chair pad assembly for selectively cushioning a user.

### BRIEF SUMMARY OF THE INVENTION

An embodiment of the disclosure meets the needs presented above by generally comprising a chair, such as one that is positioned in a vehicle, a residence, an office, and a barber shop. The chair has a seat and a backrest. The backrest is coupled to and extends from a rear edge of the seat. The backrest is configured to support a head, a neck, and a back of a user who is positioned upon the seat. A first bladder is coupled to a front of the backrest. The first bladder is selectively inflatable. The first bladder is configured to be selectively inflated to cushion the head, the neck, and the back of the user who is positioned upon the seat.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an inflatable chair pad assembly according to an embodiment of the disclosure.

FIG. 2 is an isometric perspective view of an embodiment of the disclosure.

FIG. 3 is a detail view of an embodiment of the disclosure.

FIG. 4 is a side view of an embodiment of the disclosure.

FIG. 5 is a block diagram of an embodiment of the disclosure.

### DETAILED DESCRIPTION OF THE INVENTION

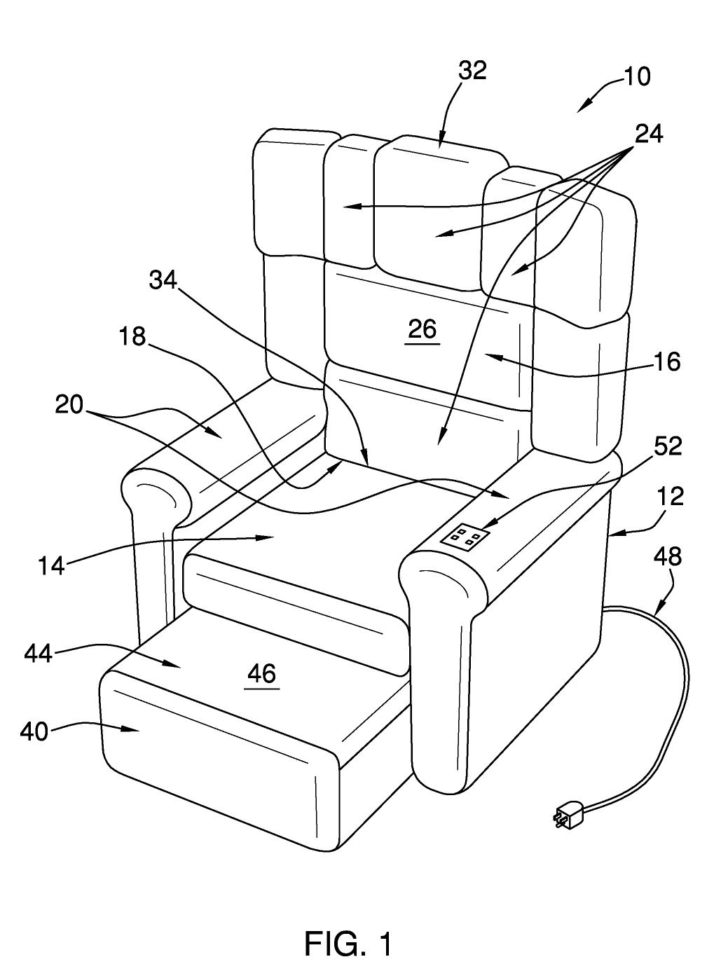

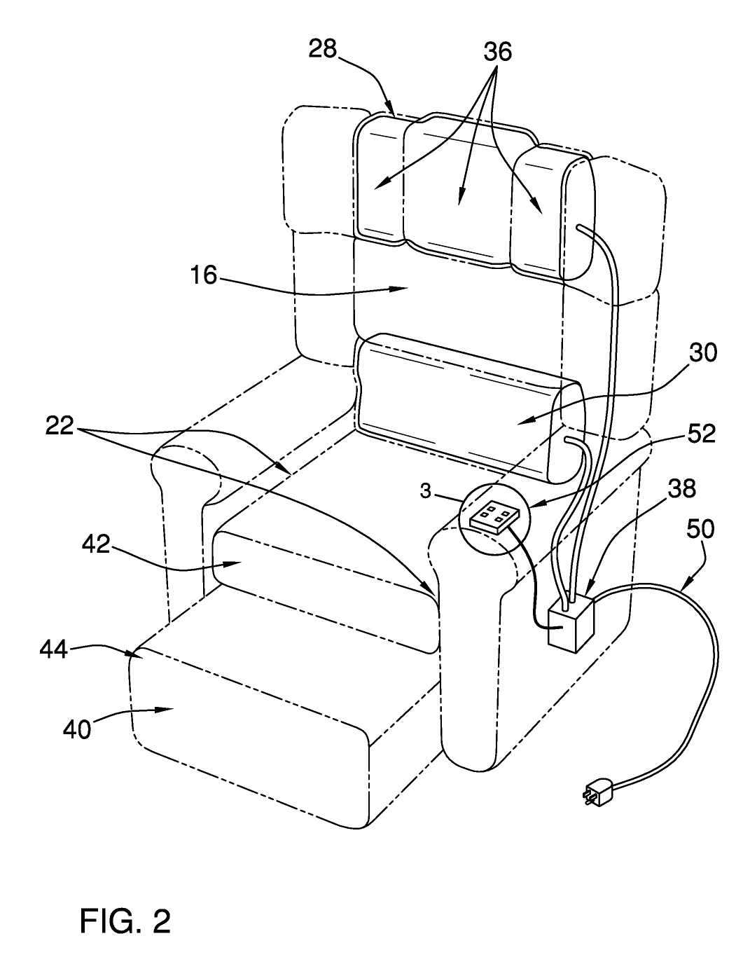

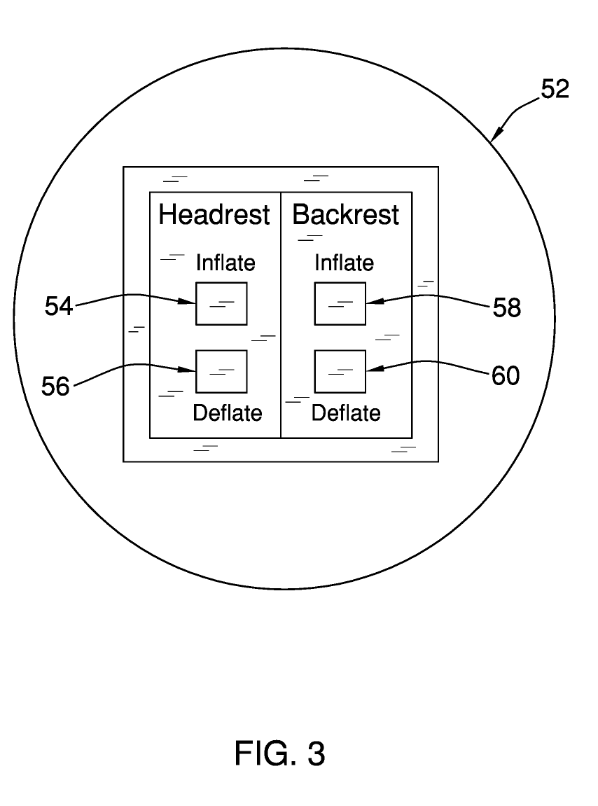

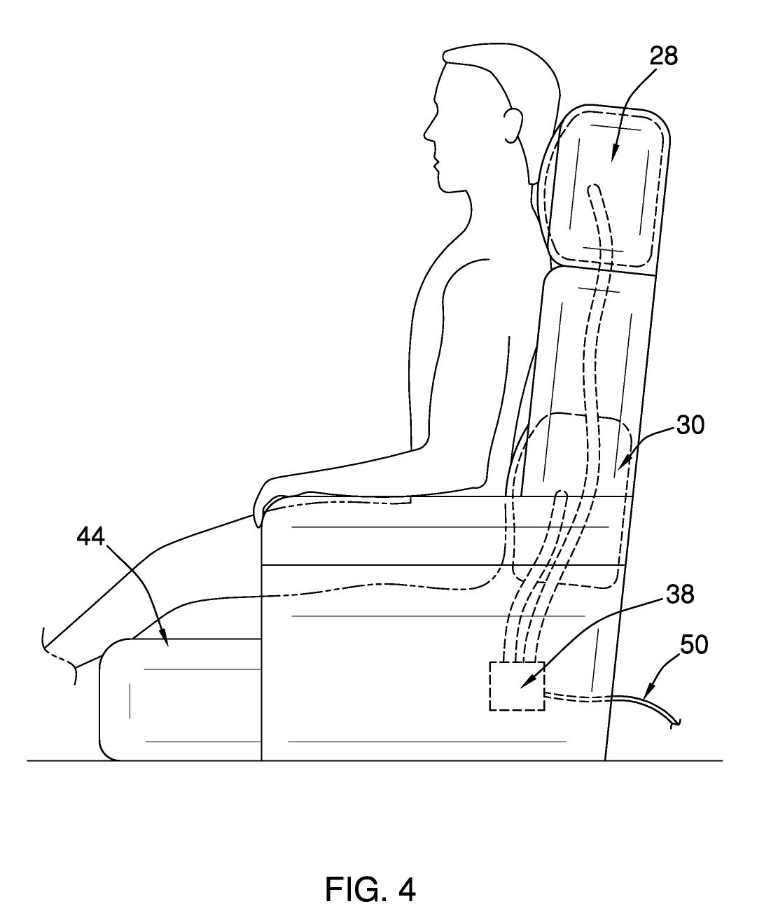

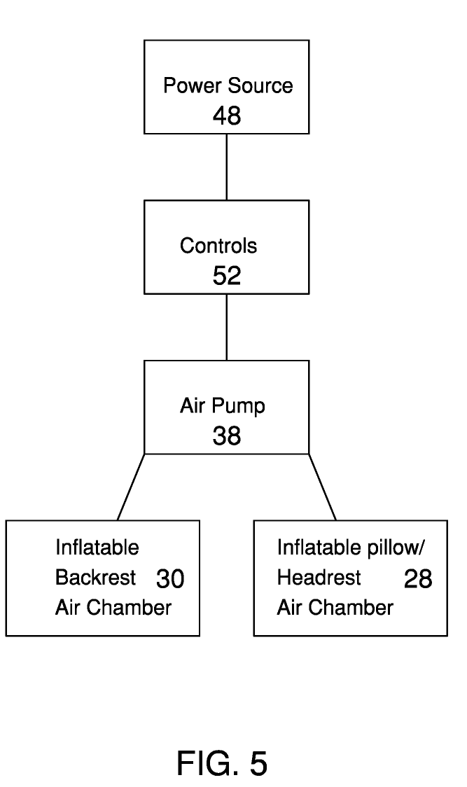

With reference now to the drawings, and in particular to FIGS. 1 through 5 thereof, a new chair pad assembly embodying the principles and concepts of an embodiment of the disclosure and generally designated by the reference numeral 10 will be described.

As best illustrated in FIGS. 1 through 5, the inflatable chair pad assembly 10 generally comprises a chair 12, such as one that is positioned in a vehicle, a residence, an office, and a barber shop. The chair 12 has a seat 14 and a backrest 16. The backrest 16 is coupled to and extends from a rear edge 18 of the seat 14. The backrest 16 is configured to support a head, a neck, and a back of a user who is positioned upon the seat 14. In one embodiment, the backrest 16 is pivotally coupled to the seat 14 so that the backrest 16 is selectively reclinable.

Each of a pair of armrests 20 is coupled to and extends from a respective opposing edge 22 of the seat 14. Each armrest 20 is configured to support a respective arm of the user who is positioned upon the seat 14.

A first bladder 24 is coupled to a front 26 of the backrest 16. The first bladder 24 is selectively inflatable. The first bladder 24 is configured to be selectively inflated to cushion the head, the neck, and the back of the user who is positioned upon the seat 14. In one embodiment, the first bladder 24 is reversibly couplable to the backrest 16. In another embodiment, the first bladder 24 comprises rubber.

In yet another embodiment, the first bladder 24 comprises an upper bladder 28 and a lower bladder 30. The upper bladder 28 is positioned proximate to an upper edge 32 of the backrest 16. The upper bladder 28 is configured to be selectively inflated to cushion the head and the neck of the user who is positioned upon the seat 14. The lower bladder 30 is positioned proximate to a lower edge 34 of the backrest 16. The lower bladder 30 is configured to be selectively inflated to cushion the back of the user who is positioned upon the seat 14. In still yet another embodiment, the upper bladder 28 comprises a plurality of chambers 36. Each chamber 36 is fluidically coupled to adjacently positioned chambers 36. In still yet another embodiment, the plurality of chambers 36 comprises three chambers 36.

At least one pump 38 is coupled to the chair 12. The at least one pump 38 is fluidically coupled to the first bladder 24. The at least one pump 38 is positioned to selectively inflate and deflate the first bladder 24. In one embodiment of the invention, the at least one pump 38 is hand-powered.

A footstool 40 is coupled to and is selectively extensible from a front face 42 of the chair 12. The footstool 40 is positioned to be extended from the front face 42 of the chair 12 so that the footstool 40 is configured to support legs and feet of the user who is positioned in the seat 14.

A second bladder 44 is coupled to a top 46 of the footstool 40. The second bladder 44 is operationally coupled to the at least one pump 38. The at least one pump 38 is positioned to selectively inflate the second bladder 44 to cushion the legs and the feet of the user who is positioned upon the seat 14. In one embodiment, the second bladder 44 comprises rubber.

A power module 48 is coupled to the chair 12. The power module 48 is operationally coupled to the at least one pump 38. In one embodiment, the power module 48 comprises a cord 50 is configured to couple to a source of alternating current.

A controller 52 is coupled to a respective armrest 20. The controller 52 is operationally coupled to the at least one pump 38 and the power module 48. The controller 52 is positioned to selectively couple the at least one pump 38 to the power module 48 to selectively inflate and deflate the first bladder 24.

In one embodiment, the controller 52 comprises a first button 54, a second button 56, a third button 58, and a fourth button 60. The first button 54, the second button 56, the third button 58, and the fourth button 60 are depressible. The first button 54 is configured to be depressed to inflate the upper bladder 28. The second button 56 is configured to be depressed to deflate the upper bladder 28. The third button 58 is configured to be depressed to inflate the lower bladder 30. The fourth button 60 is configured to be depressed to deflate the lower bladder 30.

In use, the first button 54 is configured to be depressed to inflate the upper bladder 28. The second button 56 is configured to be depressed to deflate the upper bladder 28. The upper bladder 28 is configured to be selectively inflated to cushion the head and the neck of the user who is positioned upon the seat 14. The third button 58 is configured to be depressed to inflate the lower bladder 30. The fourth button 60 is configured to be depressed to deflate the lower bladder 30. The lower bladder 30 is configured to be selectively inflated to cushion the back of the user who is positioned upon the seat 14. The footstool 40 is positioned to be extended from the chair 12 so that the footstool 40 is configured to support the legs and the feet of the user who is positioned in the seat 14. The at least one pump 38 is positioned to selectively inflate the second bladder 44 to cushion the legs and the feet of the user who is positioned upon the seat 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An inflatable chair pad assembly comprising:
a chair, said chair having a seat and a backrest, said backrest being coupled to and extending from a rear edge of said seat;
a first bladder coupled to a front of said backrest, said first bladder being selectively inflatable, said first bladder comprising:
an upper bladder positioned proximate to an upper edge of said backrest;
a lower bladder positioned proximate to a lower edge of said backrest, said lower bladder having a top edge spaced downwardly from a bottom edge of said upper bladder wherein said first bladder provides a gap on said backrest between said upper bladder and said lower bladder, said lower bladder having a front face extending continuously across said backrest; and
wherein said upper bladder is positioned on said backrest such that said upper bladder is configured for selectively inflating for cushioning the head and the neck of the user positioned upon said seat, wherein said lower bladder is positioned on said backrest such that said lower bladder is configured for selectively inflating for cushioning the back of the user positioned upon said seat; and
wherein said backrest is positioned on said seat such that said backrest is configured for supporting a head, a neck, and a back of a user positioned upon said seat, wherein said first bladder is positioned on said backrest such that said first bladder is configured for selectively inflating for cushioning the head, the neck, and the back of the user positioned upon said seat.

2. The assembly of claim 1, further including said backrest being pivotally coupled to said seat such that said backrest is selectively reclinable.

3. The assembly of claim 1, further including a pair of armrests, each said armrest being coupled to and extending from a respective opposing edge of said seat, wherein said armrests are positioned on said seat such that each said armrest is configured for supporting a respective arm of the user positioned upon said seat.

4. The assembly of claim 1, further including said first bladder being reversibly couplable to said backrest.

5. The assembly of claim 1, further including said first bladder comprising rubber.

6. (canceled)

7. The assembly of claim 1, further including said upper bladder comprising a plurality of chambers, each said chamber being fluidically coupled to adjacently positioned said chambers.

8. The assembly of claim 7, further including said plurality of chambers comprising three said chambers.

9. The assembly of claim 1, further including at least one pump coupled to said chair, said at least one pump being fluidically coupled to said first bladder, wherein said at least one pump is positioned on said chair such that said at least one pump is positioned for selectively inflating and deflating said first bladder.

10. The assembly of claim 9, further including said at least one pump being hand-powered.

11. The assembly of claim 9, further comprising:
a footstool coupled to and selectively extensible from a front face of said chair;
a second bladder coupled to a top of said footstool, said second bladder being operationally coupled to said at least one pump; and
wherein said footstool is positioned on said chair such that said footstool is positioned for extending from said front face of said chair such that said footstool is configured for supporting legs and feet of the user positioned in said seat, wherein said second bladder is positioned on said footstool such that said at least one pump is positioned for selectively inflating said second bladder for cushioning the legs and the feet of the user positioned upon said seat.

12. The assembly of claim 11, further including said second bladder comprising rubber.

13. The assembly of claim 9, further including a power module coupled to said chair, said power module being operationally coupled to said at least one pump.

14. The assembly of claim 13, further including said power module comprising a cord configured for coupling to a source of alternating current.

15. The assembly of claim 13, further comprising:
a pair of armrests, each said armrest being coupled to and extending from a respective opposing edge of said seat;
a controller coupled to a respective said armrest, said controller being operationally coupled to said at least one pump and said power module; and
wherein said controller is positioned on said armrest such that said controller is positioned for selectively coupling said at least one pump to said power module for selectively inflating and deflating said first bladder.

16. The assembly of claim 15, further including said controller comprising:
a first button, a second button, a third button, and a fourth button, said first button, said second button, said third button, and said fourth button being depressible; and
wherein said first button is positioned on said armrest such that said first button is configured for depressing for inflating said upper bladder, wherein said second button is positioned on said armrest such that said second button is configured for depressing for deflating said upper bladder, wherein said third button is positioned on said armrest such that said third button is configured for depressing for inflating said lower bladder, wherein said fourth button is positioned on said armrest such that said fourth button is configured for depressing for deflating said lower bladder.

17. An inflatable chair pad assembly comprising:
a chair, said chair having a seat and a backrest, said backrest being coupled to and extending from a rear edge of said seat, wherein said backrest is positioned on said seat such that said backrest is configured for supporting a head, a neck, and a back of a user positioned upon said seat, said backrest being pivotally coupled to said seat such that said backrest is selectively reclinable;
a pair of armrests, each said armrest being coupled to and extending from a respective opposing edge of said seat, wherein said armrests are positioned on said seat such that each said armrest is configured for supporting a respective arm of the user positioned upon said seat;
a footstool coupled to and selectively extensible from a front face of said chair, wherein said footstool is positioned on said chair such that said footstool is positioned for extending from said front face of said chair such that said footstool is configured for supporting legs and feet of the user positioned in said seat;
a first bladder coupled to a front of said backrest, said first bladder being selectively inflatable, wherein said first bladder is positioned on said backrest such that said first bladder is configured for selectively inflating for cushioning the head, the neck, and the back of the user positioned upon said seat, said first bladder being reversibly couplable to said backrest, said first bladder comprising rubber, said first bladder comprising an upper bladder and a lower bladder, said upper bladder being positioned proximate to an upper edge of said backrest, wherein said upper bladder is positioned on said backrest such that said upper bladder is configured for selectively inflating for cushioning the head and the neck of the user positioned upon said seat, said upper bladder comprising a plurality of chambers, each said chamber being fluidically coupled to adjacently positioned said chambers, said plurality of chambers comprising three said chambers, said lower bladder being positioned proximate to a lower edge of said backrest, said lower bladder having a top edge spaced downwardly from a bottom edge of said upper bladder wherein said first bladder provides a gap on said backrest between said upper bladder and said lower bladder, said lower bladder having a front face extending continuously across said backrest, wherein said lower bladder is positioned on said backrest such that said lower bladder is configured for selectively inflating for cushioning the back of the user positioned upon said seat;
at least one pump coupled to said chair, said at least one pump being fluidically coupled to said first bladder, wherein said at least one pump is positioned on said chair such that said at least one pump is positioned for selectively inflating and deflating said first bladder;
a second bladder coupled to a top of said footstool, said second bladder being operationally coupled to said at least one pump, wherein said second bladder is positioned on said footstool such that said at least one pump is positioned for selectively inflating said second bladder for cushioning the legs and the feet of the user positioned upon said seat, said second bladder comprising rubber;
a power module coupled to said chair, said power module being operationally coupled to said at least one pump, said power module comprising a cord configured for coupling to a source of alternating current;
a controller coupled to a respective said armrest, said controller being operationally coupled to said at least one pump and said power module, wherein said controller is positioned on said armrest such that said controller is positioned for selectively coupling said at least one pump to said power module for selectively inflating and deflating said first bladder, said controller comprising a first button, a second button, a third button, and a fourth button, said first button, said second button, said third button, and said fourth button being depressible, wherein said first button is positioned on said armrest such that said first button is configured for depressing for inflating said upper bladder, wherein said second button is positioned on said armrest such that said second button is configured for depressing for deflating said upper bladder, wherein said third button is positioned on said armrest such that said third button is configured for depressing for inflating said lower bladder, wherein said fourth button is positioned on said armrest such that said fourth button is configured for depressing for deflating said lower bladder; and
wherein said first button is positioned on said armrest such that said first button is configured for depressing for inflating said upper bladder, wherein said second button is positioned on said armrest such that said second button is configured for depressing for deflating said upper bladder, wherein said upper bladder is positioned on said backrest such that said upper bladder is configured for selectively inflating for cushioning the head and the neck of the user positioned upon said seat, wherein said third button is positioned on said armrest such that said third button is configured for depressing for inflating said lower bladder, wherein said fourth button is positioned on said armrest such that said fourth button is configured for depressing for deflating said lower bladder, wherein said lower bladder is positioned on said backrest such that said lower bladder is configured for selectively inflating for cushioning the back of the user positioned upon said seat, wherein said footstool is positioned on said chair such that said footstool is positioned for extending from said chair such that said footstool is configured for supporting legs and feet of the user positioned in said seat, wherein said second bladder is positioned on said footstool such that said at least one pump is positioned for selectively inflating said second bladder for cushioning the legs and the feet of the user positioned upon said seat.

18. The assembly of claim 17, further including said at least one pump being hand-powered.
